(19) United States
(12) Patent Application Publication
(10) Pub. No.: US 2013/0059033 A1
(43) Pub. Date: Mar. 7, 2013

(54) METHOD OF OBTAINING FRESH SPUN CHEESE

(71) Applicant: Louisa-Karina Morariu, Lupeni (RO)

(72) Inventor: Louisa-Karina Morariu, Lupeni (RO)

(73) Assignee: Abdulvahit ECE, Lupeni (RO)

(21) Appl. No.: 13/697,152

(22) PCT Filed: Nov. 25, 2009
(86) PCT No.: PCT/RO10/00019

§ 371 Date: Nov. 9, 2012

(30) Foreign Application Priority Data
May 12, 2010 (RO) A 2010 00426

(51) Int. Cl. A23C 19/068

(52) U.S. Cl. 426/40; 426/582

(57) ABSTRACT

The invention refers to a cheese type food product and the method of production. The product, according to the invention, has a content of 61,32% water, 1,5% fats, 39% proteins, 7,67% sodium chloride, 41, 58% fat in dry substance, a pH value of 5,43. The method, according to the invention, consists of heating milk up to a temperature of 28 . . . 30 C, after which it is filtrated, separated up to a content of 0,15% in fat volume, then natural fermentation up to a pH value of 5,4 and the introduction in the milk mass of the enzymatic curd; the mixture is heated up to a temperature of the milk mass of 65 . . . 70 C, then liquid enzymatic curd is introduced, mixing continuously, to form a block of ewe-cheese of which whey is eliminated and it is submitted to manual kneading in pieces of 10 kg, which are subsequently left to drain, they are kept in 10% brine solution for 24h, they are left to dry for 2 . . . 3 h and the result is a non-fat cheese with fibrous aspect, which is packed.

The invention refers to a fresh spun cheese and the method of obtaining this product. Particularly, the invention refers to the method of obtaining a new sort of cheese that has no paste and has a fibrous and elastic texture.

In the food industry there is a request for cheese with the taste of fresh and easily acidified dairy products.

Cheese contains almost all milk components, but in much higher proportions due to their concentration following whey elimination and the retention of lipids, lipo-soluble vitamins and mineral salts in the mass of casein curd of the lipids. Thus, enzymatic curdling cheeses are true food product concentrates of nutritious substances. The presence of vitamin D together with the high content of calcium and phosphorus, as well as their optimum ratio, determines cheeses to be considered the best sources for these elements. They are poor in potassium and rich in sodium.

In most cheeses there is no lactose, or there are very small quantities (1-3 g/100 g) because part of it transforms to whey, and the one retained by the cheese curd is partially or entirely transformed into lactic acid during cheese curing. This is why cheeses are recommended in the diets of persons suffering from lactose intolerance or diabetes.

Cheeses are food products with special characteristics under the aspect of their input of important minerals from a nutritious point of view: calcium, phosphorus, magnesium.

Moreover, in the food industry there are no sorts of cheese with no paste, this being the only one, which proves the novelty and invention characteristics of this cheese type and of its method of production, consumable both as an appetizer and in other specific culinary courses.

Cheeses are products obtained by coagulation of the casein specific to the resulted curd. The type range is very wide, depending on the nature of the milk, the consistency and the technological process.

Fresh cheeses are obtained through the acid coagulation of casein and are characterized by their creamy consistency, high humidity, lactic fermentation taste and flavor. They contain 13-16% proteins and a variable lipids percentage, depending on the type (0.5-9%). They have a high dietary value due to the high methionine and choline content, representing a protective food product for the hepatic cell.

Fermented cheeses—cured in brine are obtained through the enzymatic coagulation, short term curing in brine, after processing the ewe-cheese, with whey elimination. Within the type, “telemea” cheese is on the first place in cheese production in our country, being considered a traditional product. It has a nutritious value similar to meat (approximately 20% proteins; 25-30% lipids); the calcium content is above 500 mg/100 g.

Steamed cheeses have as specific technological operation steaming ewe-cheese resulting from cow, sheep or mixed milk, in a solution of Na₂Cl 12%. The result is mass with plastic properties, which is introduced in characteristic shapes and curing for a long time. They contain approximately 24% proteins and 19-25% lipids.

The type of cheese that we present has a method of production that combines elements characteristic to the 3 groups presented above, respectively: fresh cheeses, fermented-cured in brine and steamed but it is also substantially different from those because:

1. compared to fresh cheese, it presents similarities determined by high humidity, fermentation taste and flavor, but it is different from this type through its creamy consistency and the protein content.

2. compared to cheeses fermented-cured in brine, it presents similarities determined by the enzymatic coagulation, short term curing, ewe-cheese processing with whey elimination, but it is different through the higher protein content and the other kneading, stretching operations, the method of production and the elastic and fibrous aspect with no compact mass.

3. compared to steamed cheeses it presents similarities regarding the final resulted product, which is a mass of plastic properties, but is different from this group with regards to the paste consistency with homogenous mass, of the steaming process, the registered protean value.

Due to these differences in relation to the other cheese types, from which it combines some common parts, this new cheese type results, with an equally new method of production, with the following characteristics:

it is a fresh fermented cheese with a low curing degree

it is a cheese obtained from unpasteurized milk

it is a paste-free cheese

it is a white cheese

it is a cheese with no compact mass

it is a cheese with a semi-hard, fibrous and elastic consistency

it does not have a crust

it is not crumbly

it is not-sticky

it has a crusty surface

it has the aspect of a “thread bundle”

There is no product that entirely shows similarities with this description, but small similarities under the aspect of fibrous and elastic consistency, but obtained through another method and which has a crust and a compact creamy mass. It is the Mozzarella cheese, respectively American patents US005925398A and US005567464A and the French patent WO 2005/032266 A2 by which a fibrous and elastic consistency cheese is obtained, but by adding yogurt to the mozzarella cheese, used as raw material and processed into an extruder.

The inventor of the present invention concluded that the reproduction of the method according to the above mentioned American patents leads to a product with a lower protean value, a high fat quantity in the dry substance, a product that contains emulsifiers—sodium nitrate—in different quantities for conservation under normal temperature conditions, without the need of conservation in refrigerated areas, through the process of steaming of the mozzarella cheese and then by processing it with the help of a double extruder and incorporating the sodium nitrate in two stages.

A drawback of these methods is represented by the short conservation period, the low content of protean mass necessary for a balanced nutrition and the consumption period after only a few weeks after production due to the necessary curing time.

Another drawback is determined by the short conservation time after unpacking, by the addition of food additives as emulsifiers: citrates or nitrates, by its aspect and consistency.

One object of the present invention is to provide a cheese product totally different from the ones presented above.

Another object of the present invention is to provide a rapid a cheap preparation method for a new market product.

Another object of the present invention is to provide a fat-free product with a high protean value, a low fat content, an ecological and natural product that does not contain food additives.

Another object of the present invention is the preservation effect of the cheese that is provided both my reducing the whey quantity of the mass because the 4.32-5.43 pH that is characteristic to this type of cheese leads to an almost complete elimination of the whey from the cheese mass and an absorption of water into the brine.

Another object of the present invention is given by the acidification resulting from the lactic fermentation that slow the development of putrefaction bacteria since this invention is based on a method according to which sour milk is no longer submitted to the coagulation operation of naturally fermented milk by which yogurt is formed but only to coagulation by adding enzymatic curd.

The casein-phospho calcium complex is modified more at temperatures above 75 C. The existent balance between casein-phospho micelle and soluble mineral salts is affected, one part of the soluble calcium salts passing into the insoluble tricalcium phosphate. These modifications produce difficulties in coagulating milk with curd, which drawback is removed by adding calcium chloride.

At temperatures above 70 C, the lactose is partially decomposed by balancing acids, alcohols and aldehyde.

Heating up at high temperature favors the formation of a complex between proteins and lactose, producing milk browning—the Maillard reaction. This reaction reduces the nutritious value of the milk by blocking the lysine in the formed complex.

The inventor realized that with the help of this specific preparation method an unclassified cheese type is obtained, which takes over characteristics, similarities and certain parts of the production method of several cheeses.

Thus, with the help of this specific preparation method a paste-free cheese is obtained, which has and entire fibrous and elastic mass, breakable by hand, that is it can be split manually in strips without crumbling, it has an easily acid fermented taste of fresh cheese, it is fat-free and with a normal fat content, it presents an entirely white surface and it is a fresh pasteurized and rapidly cured product.

In a preferred realization example for the method, a cheese product is obtained, with a fibrous consistency with no paste, homogenous and compact, the flavor of a fresh yet naturally cured cheese showing a good preservation quality.

In the preparation procedure with the help of this method specific to the present invention, a fresh non-fat spun cheese.

In an example of this classification, the following types of uncured or slightly cured cheese products can be found, such as: mozzarella, sweet cow cheese, pressed cow cheese, non-fat cheese, ricotta, ricotone, spun paste, scamorza.

According to the Lexicon, the curing degree of cheeses represents the ratio between soluble nitrous fractions and the total produced nitrogen, at a certain moment of the curing process.

The curing volume is determined by the ratio between the water soluble nitrogen and the total nitrogen.

Produced cheeses can be grouped as such:

very low curing degree: up to 15%

low curing degree : 15-30%

high curing degree: 30-50%

very low curing degree: 50-80%

To exemplify, it is shown that the first group, with a very low curing degree, includes fresh cheeses and the following group includes brine cheeses and those with steamed paste.

Because the cheese type whose method of production is presented here has a ratio between water-soluble nitrogen and total nitrogen of 10-20% it is part of the fresh and brine cheese category.

The method and the product complying with the patent are subsequently explained, but not limited whatsoever, through the following examples:

### EXAMPLE 1

Heat 1000 1 of milk at the temperature of 28-30 C by steam ebullition at the pressure of 2 atmospheres.

Then filtrate the milk for possible impurities and other foreign bodies.

After filtration, milk is stored in a 1000 1 tank, from where it is transferred into the separator at a speed of 7.000 rot./min, the result being milk with a thickness of 0,15% in volume.

This is the normalization operation after which the milk has a uniform thickness throughout its entire mass.

After these prior operations, the milk is left to settle, which is when milk souring is produced by natural lactose fermentation determined by the presence of lactic ferments that transform it into lactic acids at an optimum temperature of 28-30 C. This operation is considered finished after a time period influenced by the season and the temperature of the production space and which is generally marked by a pH of 5,4 or if, when taking a quantity of the milk left to sour with a spoon and putting it over a flame to heat, the sour milk starts to curdle, separating from the whey. The so-called “curdling” marks the end of this operation, which is particularly important because, if the milk isn't sufficiently well curdled, the final product cannot be obtained, which in our case is the fresh non-fat spun cheese. This operation is the most sensitive one.

A 8-20 ml quantity of liquid enzymatic curd is introduced in the total mass of sour milk, of 1:15000, which is well incorporated in the entire mass of sour milk.

Immediately after incorporating the liquid enzymatic curd follows the second heating of the sour milk through the same installation for steam ebullition, until the temperature of the sour milk mass at the temperature of 65-70 C.

After reaching this optimum temperature the milk heating and temperature stabilization around this temperature is stopped and then in the total cheese mass that starts to form a new quantity of liquid enzymatic curd is added, respectively 8-20 ml, continuing the mixing operation until the complete formation of the ewe-cheese block. After formation the block is only pressed to remove the whey.

The newly formed cheese block of approximately 100 kg is left in the tank in which it was obtained and 10 kg pieces are cut from it, which are processed separately in another tank.

This tank is exclusively used to take out the whey and for manual kneading, being necessary to carry out the kneading this way in order to obtain the fibrous, uniform aspect of the entire surface of fresh cheese.

After these operations a 40 cm piece is obtained, which is hung to drain and which will subsequently double its own length while it drains, respectively up to the moment it is 100-150% longer than initially.

Subsequently it will be kept in brine of 10% solution for approximately 24 hours, and after that it is taken out and left to dry around 2-3 hours then it is cut into pieces of different weights and packed in vacuous plastic foil.

From this example a fresh non-fat spun cheese is obtained, with the following characteristics:

Water: 61.32%

Fat: 1.5%

Fat in dry substance: 41.58%

Proteins: 39.39%

Salt: 7.67%

Water-soluble nitrogen/Total nitrogen—20,18%

pH: 5.43

### EXAMPLE 2

Example 1 was repeated with milk that was run through the separator and the normalization process was carried out for milk with a fat content of 0.38% in volume.

After following the exact same stages in example 1, the result is a fresh spun cheese with a normal fat content, with the following characteristics:

Water: 44%

Fat: 3.8%

Fat in dry substance: 45%

Proteins: 33%

Salt: 5.5%

Water-soluble nitrogen/Total nitrogen—10,65%

pH: 4.7

1-8. (canceled)

9. A method of obtaining a product, fresh spun cheese, starting from fresh cow or sheep milk and continuing the following production stages:
a) heating milk at a temperature between 28-32 C;
b) milk filtration;
c) milk degreasing;
d) lactic fermentation for a sufficient time up to a pH of 5.4;
e) adding liquid enzymatic curd in a proportion of 7.5-18.5% in volume reported to the total mass of the mixture;
f) heating the mixture by steam ebullition up to the temperature of 65-70 C and adding the second part of liquid enzymatic curd;
g) formation of the new ewe-cheese block and cutting into pieces;
h) manual processing by kneading in a sufficient time to obtain a cheese mass with fibrous and elastic texture;
i) suspension on supports to eliminate the remaining whey and stretch under its own weight, becoming 100-150% more stretched and spread;
j) introduction and keeping in brine with a concentration of 12-17% for approximately 20-24 hours to adjust humidity, decrease the acidity, improve taste as well as preservation by inhibiting the development of microorganisms; and
k) Taking out of brine, drying, portioning, packing in vacuous plastic foil and storage.

10. The method according to claim 9, in which stage c) is carried out up to 0.15% in fat volume, the result being a fresh non-fat spun cheese product.

11. The method according to claim 9, in which stage c) is carried out up to 0.3% in fat volume, the result being a fresh spun cheese product with a normal fat content.

12. The method according to claim 11, in which stage d) is carried out in a shorter time, by adding previously resulted whey.

13. The method according to claim 9, in which flavors, colorants, preservatives and other additives and bacterial cultures adequate for food products are added, as well as other microorganisms.

14. The method according to claim 10, in which flavors, colorants, preservatives and other additives and bacterial cultures adequate for food products are added, as well as other microorganisms.

15. The method according to claim 11, in which flavors, colorants, preservatives and other additives and bacterial cultures adequate for food products are added, as well as other microorganisms.

16. The method according to claim 9, in which ingredients such as olive, fruit, vegetable pieces, greens and olive oil are added.

17. The method according to claim 10, in which ingredients such as olive, fruit, vegetable pieces, greens and olive oil are added.

18. The method according to claim 11, in which ingredients such as olive, fruit, vegetable pieces, greens and olive oil are added.

19. The method according to any of claim 9, in which stages a)-g) are realized by mechanical and thermal treatment using the centrifuge separator, the mixer, the steam generator with the corresponding ebullition installation.

20. The method according to any of claim 10, in which stages a)-g) are realized by mechanical and thermal treatment using the centrifuge separator, the mixer, the steam generator with the corresponding ebullition installation.

21. The method according to any of claim 11, in which stages a)-g) are realized by mechanical and thermal treatment using the centrifuge separator, the mixer, the steam generator with the corresponding ebullition installation.

22. The method according to any of claim 12, in which stages a)-g) are realized by mechanical and thermal treatment using the centrifuge separator, the mixer, the steam generator with the corresponding ebullition installation.

23. The method according to any of claim 13, in which stages a)-g) are realized by mechanical and thermal treatment using the centrifuge separator, the mixer, the steam generator with the corresponding ebullition installation.

24. The method according to any of claim 14, in which stages a)-g) are realized by mechanical and thermal treatment using the centrifuge separator, the mixer, the steam generator with the corresponding ebullition installation.

25. A cheese with solid, semi-hard, elastic and fibrous texture with the taste of fresh, slightly acidified dairy product, susceptible of being obtained according to claim 9.

26. The cheese with solid, semi-hard, elastic and fibrous texture with the taste of fresh, slightly acidified dairy product, susceptible of being obtained according to claim 10.

27. The cheese with solid, semi-hard, elastic and fibrous texture with the taste of fresh, slightly acidified dairy product, susceptible of being obtained according to claim 11.

28. The cheese with solid, semi-hard, elastic and fibrous texture with the taste of fresh, slightly acidified dairy product, susceptible of being obtained according to claim 12.
